(19) United States
(12) Patent Application Publication
(10) Pub. No.: US 2016/0071038 A1
(43) Pub. Date: Mar. 10, 2016

(54) SYSTEMS AND METHODS FOR FACILITATING EMPLOYEE RETENTION

(71) Applicant: Saba Software, Inc., Redwood Shores, CA (US)

(72) Inventors: Hemanth Puttaswamy, Fremont, CA (US); Bernard P. Willis, San Francisco, CA (US); Motiur Rahman, North Harrow (GB); Shawn S. Lozano, Rocklin, CA (US)

(73) Assignee: Saba Software, Inc., Redwood Shores, CA (US)

(21) Appl. No.: 14/806,741

(22) Filed: Jul. 23, 2015

Related U.S. Application Data
(60) Provisional application No. 62/045,626, filed on Sep. 4, 2014.

(51) Int. Cl. G06Q 10/06; G06F 3/0484

(52) U.S. Cl. CPC G06Q 10/06312; G06F 3/0484

(57) ABSTRACT

Techniques are described for facilitating an organization's retention of employees through improved compensation planning A subset of the organization's employees who are “at risk” (e.g., who are a risk to depart the organization, who are a high value employee to the organization, who are underpaid by the organization, and/or based on other factor(s)) may be identified. The cost of replacing these “at risk” employees may then be estimated, in any suitable fashion. The budgeted compensation for each “at risk” employee may be compared to an amount calculated based upon the estimated replacement cost for that employee (e.g., a percentage of the estimated replacement cost for the employee). If the budgeted compensation is less than the amount, then a recommendation to increase compensation for the employee may be generated and presented, such as via a graphical user interface.

### RELATED APPLICATIONS

This application claims the benefit under 35 U.S.C. §119(e) of the filing date of commonly assigned U.S. Provisional Application Serial No. 62/045,626, entitled “SYSTEMS AND METHODS FOR FACILITATING EMPLOYEE RETENTION,” filed Sep. 4, 2014, bearing Attorney Docket No. S1612.70007U500, the entirety of which is incorporated herein by reference.

### BACKGROUND

Many organizations perform a periodic process to define a compensation budget specifying how employees are to be compensated. In larger organizations, a central administrative team often determines an aggregate amount that is to be paid to groups of employees in the organization (e.g., those who work in a particular geographic region, who perform a particular function, etc.), and this aggregate amount is used as a frame of reference by lower-level managers in recommending compensation for the individual employees in a group. An employee's compensation may take various forms, including salary, bonus, lump sum payments and/or stock/option awards.

### SUMMARY OF INVENTION

Some embodiments of the invention provide systems and methods for facilitating retention of an organization's employees through improved compensation planning In accordance with some embodiments of the invention, a subset of the organization's employees who are “at risk” are identified, based on any suitable criteria. In some embodiments of the invention, an employee may be identified as “at risk” if he/she is deemed to be a risk to depart the organization, if he/she is deemed a high value employee to the organization, if he/she is deemed to be underpaid by the organization, and/or based on one or more other factors. The prospective cost to the organization of replacing these “at risk” employees may then be determined. This prospective cost may be determined in any of numerous ways. In some embodiments, the prospective replacement cost may include estimated amounts for recruiting, training, and compensating a replacement for each “at risk” employee.

Some embodiments of the invention may then compare budgeted compensation for each “at risk” employee to an amount which is based upon the estimated replacement cost for that employee. For example, the budgeted compensation may be compared to an amount representing a percentage of the estimated replacement cost. Any suitable percentage may be used, and the percentage may vary by employee, employee group, etc. If the budgeted compensation is less than the amount, then a recommendation may be presented (e.g., via a user interface, such as to someone in the organization tasked with compensation planning) to increase the budgeted compensation for the employee. By appropriately increasing compensation for “at risk” employees, organizations may be more likely to retain these employees, and avoid the significant costs associated with replacing these employees with other personnel.

The foregoing is a non-limiting summary of some aspects of the invention, some embodiments of which are defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flow chart depicting an example technique for managing employee compensation, in accordance with some embodiments of the invention;

FIG. 2 depicts a representative technique for identifying employees who are critical to an organization, in accordance with some embodiments of the invention;

FIG. 3 depicts an example technique for determining recommended compensation for “at risk” employees, in accordance with some embodiments of the invention;

FIG. 4 depicts a representative user interface for making recommendations regarding employee compensation, in accordance with some embodiments of the invention;

FIG. 5 depicts a representative user interface for making compensation recommendations for “at risk” employees, in accordance with some embodiments of the invention; and

FIG. 6 depicts a representative computer system which may be used to implement certain aspects of some embodiments of the invention.

### DESCRIPTION

Some embodiments of the present invention are directed to facilitating retention of an organization's employees via employee compensation planning In some embodiments, a subset of the organization's employees who are “at risk” are identified, based on any suitable criteria. For example, an employee may be identified as being “at risk” if he/she is deemed to be a departure risk, is a “high value” employee to the organization, is underpaid, and/or based on one or more other factors. The prospective cost of replacing these employees is then estimated, such as based upon estimated amounts for recruiting, training, and compensating replacement personnel for each employee. An amount is then calculated based on the prospective replacement cost (e.g., a percentage of the replacement cost), and the budgeted compensation for each “at risk” employee is compared to this amount. If the budgeted compensation for an employee is less than the amount, then a recommendation may be generated and presented (e.g., via a graphical user interface) to increase the budgeted compensation (e.g., in the form of a salary increase, bonus, lump-sum payment, and/or other form(s) of compensation) for the employee. By increasing compensation for “at risk” employees to account for the prospective cost of replacing those employees, organizations may be more likely to retain them, and avoid the significant costs associated with replacing them.

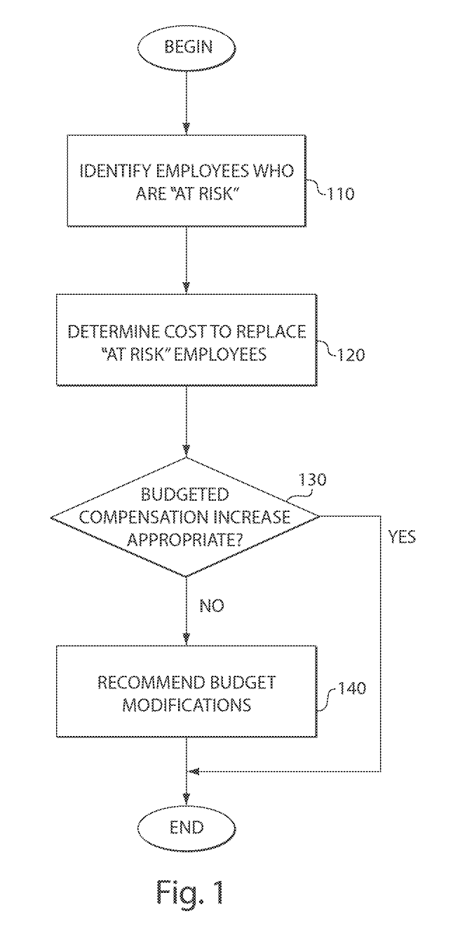

FIG. 1 depicts a representative process 100 for use by an organization to manage employee compensation to aid in employee retention. At the start of representative process 100, employees who are “at risk” are identified in act 110. This may be performed in any of numerous ways, such as by analyzing any of various types of data maintained by the organization on the employees. The employees who are identified as being “at risk” may satisfy any of numerous criteria. In accordance with some embodiments of the invention, the employees who are “at risk” are identified as those who are deemed a risk to depart the organization, have great value to the organization, and/or who are underpaid relative to employees of other organizations who perform similar functions. Of course, embodiments of the invention are not limited to identifying “at risk” employees using these criteria, as any suitable criteria may be employed.

Employees deemed to be a risk to depart the organization may be identified in any of numerous ways. For example, an employee may be identified as a departure risk if he/she is a member of an organization which previously has experienced turnover exceeding a predetermined threshold, reports to a manager whose direct reports leave the organization at a rate exceeding a predetermined threshold, works in a location which previously has experienced turnover exceeding a predetermined threshold, and/or performs a job which other employees previously have left at a rate exceeding a predetermined threshold. An employee may also, or alternatively, be deemed a departure risk based upon an analysis of data relating to the employee and/or the function that he/she performs. As one example, if an analysis of market data reveals that employees with the title “systems administrator” are suddenly in great demand, and are receiving large compensation increases upon accepting jobs with new organizations, then employees of the organization with that title may be identified as departure risks. As other examples, analyses of search strings, email content and/or other data may reveal an employee's intent to depart an organization, and may lead to the employee being identified as a risk to depart the organization.

Employees who have great value to the organization may also be identified in any of numerous ways. For example, if an employee performs a role which has been deemed as critical to the organization, and/or if the employee has been identified as a consistent top performer, then he/she may be identified as having great value to the organization.

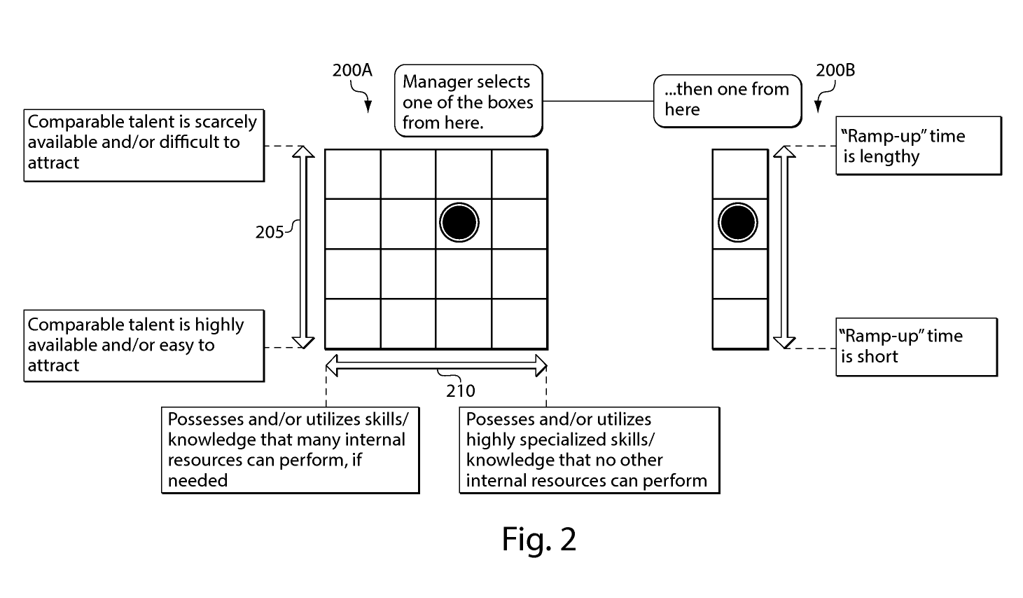

An example approach to identifying high-value employees is illustrated in FIG. 2, which depicts matrices 200A and 200B. It can be seen from FIG. 2 that matrix 200A has a vertical dimension 205 and a horizontal dimension 210. Vertical dimension 205 measures how difficult it would be to replace a particular employee. An employee is deemed difficult to replace, and placed in a cell nearer the “top” of vertical dimension 205, if comparable talent is scarcely available or difficult to attract. Conversely, an employee is deemed not difficult to replace, and placed in a cell nearer the “bottom” of vertical dimension 205, if comparable talent is highly available and/or easy to attract. Horizontal dimension 210 measures how difficult it would be for the organization to replace the employee's skill set. An employee's skills are ascribed higher value, and the employee is placed in a cell nearer the right-hand edge of horizontal dimension 210, if the employee possesses and/or utilizes highly specialized skills or knowledge that few other internal resources can duplicate. Conversely, an employee's skills are ascribed lower value, and the employee is placed in a cell nearer the left-hand edge of horizontal dimension 210, if the employee possesses and/or utilize skills or knowledge that many other internal resources can provide if needed. Thus, it can be seen that, using this approach, employees placed in a cell nearer the top and/or right-hand edge of matrix 200A have higher value to the organization than those placed nearer the bottom and/or left-hand edge of matrix 200A.

Matrix 200B has only a vertical dimension, and measures how much time it would take to train a replacement to perform an employee's function. An employee is placed nearer the top of matrix 200B if the replacement's “ramp up” time would be lengthy, and nearer the bottom of matrix 200B if the replacement's “ramp up” time would be relatively short.

The assessments performed using matrices 200A and 200B may be combined into a composite assessment of an employee's value to the organization. This may be accomplished in any suitable fashion. In some embodiments of the invention, the cells in each matrix may each be assigned a score, and the assessments may be combined by multiplying the score associated with the cell in which the employee is placed in matrix 200A by the score associated with the cell in which the employee is placed in matrix 200B. Of course, other techniques for combining these assessments may alternatively be used.

It should be appreciated that the approach to identifying employees that have great value to the organization set forth in FIG. 2 is merely representative, and that any suitable technique(s) may be employed. Embodiments of the invention are not limited to any particular mode of implementation.

Returning to act 110, employees who are underpaid may also be identified in any of numerous ways. In some embodiments of the invention, a determination whether an employee is underpaid may be based upon an assessment of the compensation budgeted for the employee by his/her manager relative to the market value (e.g., what other organizations are currently paying for employees who perform similar functions, have similar experience levels, etc.) of the employee. For example, if the manager's recommendation is not at least a certain over the mid-point salary paid to other employees performing the same function and having similar experience in other organizations, then the employee may be deemed underpaid. In some embodiments, a determination whether an employee is underpaid may be based upon an assessment of the budgeted compensation for the employee relative to peer compensation rates (e.g., how much the organization for which the employee works pays other employees in similar roles, performing similar functions, and/or having similar responsibilities). Of course, any suitable technique may be used to identify underpaid employees, as embodiments of the invention are not limited to any particular mode of implementation.

In some embodiments of the invention, an employee may be identified as being “at risk” if he/she satisfies any suitable combination of criteria set forth above. For example, some organizations may identify an employee as being “at risk” only if he/she satisfies all three of the criteria described above (i.e., is deemed a risk depart the organization, is deemed to have great value to the organization, and is determined to be underpaid). Other organizations may identify an employee as being “at risk” if he/she satisfies any one of the criteria described above (i.e., is deemed a departure risk, has great value to the organization, or is deemed underpaid). Other organizations may identify an employee as being “at risk” if some combination of the above-described criteria are satisfied (e.g., if the employee is deemed underpaid and has great value to the organization, or if the employee is a departure risk). Any suitable combination of factors may be used to identify “at risk” employees.

It should also be appreciated that embodiments of the invention are not limited to employing only the three factors described above to identify “at risk” employees. Embodiments of the invention may consider any suitable number and type(s) of factors in performing this assessment.

At the completion of act 110, representative process 100 proceeds to act 120, wherein a cost to replace the “at risk” employees identified in the act 110 is determined. This may be performed in any suitable fashion. In some embodiments of the invention, the cost to replace the identified “at risk” employees may be estimated based in part upon the anticipated cost to recruit each employee's replacement, to train the replacement during an initial “ramp up” time period, and the likely need to pay a premium on the employee's current salary to attract the replacement. Of course, prospective replacement costs may be estimated using any suitable figure(s) and technique(s), and embodiments of the invention are not restricted to any particular approach.

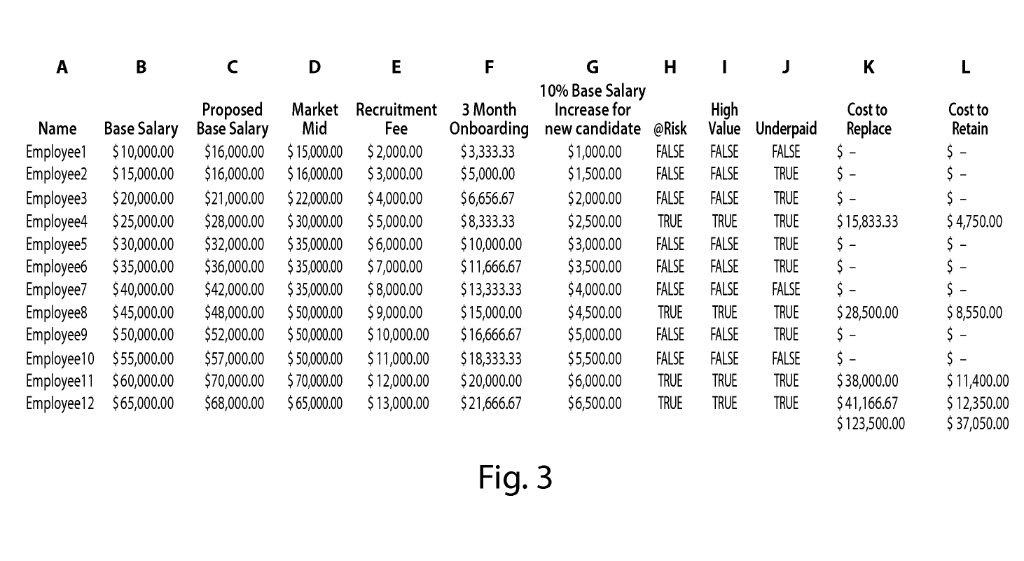

FIG. 3 illustrates an approach to estimating prospective replacement costs which uses anticipated recruitment, training and compensation costs. The representative matrix 300 shown in FIG. 3 includes information for twelve hypothetical employees, in columns labeled “Base Salary” (column B), “Proposed Base Salary” (column C), “Market Mid” (column D), “Recruitment Fee” (column E), “3 Month Onboarding” (column F), “10% Base Salary Increase for new candidate” (column G), “@RISK” (column H), “High Value” (column I), “Underpaid” (column J), “Cost To Replace” (column K), and “Cost to Retain” (column L). In representative matrix 300, the information in column H (i.e., “TRUE”) indicates that employees 4, 8, 11 and 12 have been identified (e.g., using the process outlined above) as being “at risk.” Column E shows an estimated fee to recruit a replacement for each of these employees to the organization. This estimated fee may be determined in any suitable fashion, such as based upon fees recently paid to recruiting agencies for locating employees in similar roles and/or at similar salary levels, based upon referral bonuses recently paid for locating employees in similar roles/salary levels, and/or other information. In the example shown in FIG. 3, the estimated fee to recruit employee 4's replacement is $5,000.00, the estimated fee to recruit employee 8′s replacement is $9,000.00, the estimated fee to recruit employee 11′s replacement is $12,000.00, and the estimated fee to recruit employee 12′s replacement is $13,000.00.

In the example of FIG. 3, the estimated cost to train the replacement for each “at risk” employee is shown in column F, and is estimated as being equal to a portion (specifically, one-third) of the employee's base salary, shown in column B. Thus, it can be seen that the estimated cost to train employee 4's replacement is $8,333.33 (i.e., one-third of employee 4's $25,000.00 base salary), the estimated cost to train employee 8's replacement is $15,000.00 (i.e., one-third of employee 8's $45,000.00 base salary), the estimated cost to train employee 11's replacement is $20,000.00 (i.e., one-third of employee 11's $60,000.00 base salary), and the estimated cost to train employee 12's replacement is $21,666.67 (i.e., one-third of employee 12's $65,000.00 base salary). Of course, the cost associated with training a particular employee's replacement may be determined in any suitable fashion, and need not be based upon the employee's base salary. Any information and/or technique(s) may alternatively be used.

In the example of FIG. 3, the estimated salary premium to be paid to attract an employee's replacement is shown in column G, and is estimated as 10% of the employee's current salary, shown in column B. Thus, given employee 4's base salary of $25,000.00, the premium to be paid to attract employee 4's replacement is estimated to be $2,500.00. Given employee 8's base salary of $45,000.00, the premium to attract employee 8's replacement is estimated to be $4,500.00. Given employee 11's base salary of $60,000.00, the premium to attract employee 11's replacement is estimated to be $6,000.00. Given employee 12's base salary of $65,000.00, the premium to attract employee 12's replacement is estimated to be $6,500.00. Of course, any information and/or technique(s) for estimating a salary premium to be paid to attract an employee's may alternatively be used.

It can be seen from the foregoing that the estimated cost to replace employee 4 is $15,833.33 (i.e., the sum of the $5,000.00 estimated recruitment cost, the $8,333.33 estimated training cost, and the $2,500.00 estimated salary premium). The estimated cost to replace employee 8, calculated in the same manner, is $28,500.00. For employee 11, the estimated replacement cost is $38,000.00, and for employee 12, the estimated replacement cost is $41,166.67.

It should be appreciated, of course, that the cost associated with replacing an employee may be estimated in any suitable fashion, using any suitable information, and that the approach described with reference to FIG. 3 is merely representative. It should also be appreciated, nonetheless, that the estimated replacement cost for each “at risk” employee is significant, and represents a substantial portion of the amount currently paid to each employee.

Returning to FIG. 1, at the completion of act 120, representative process 100 proceeds to act 130, wherein a determination is made whether the budgeted compensation amount for each employee identified as being “at risk” in act 110 is appropriate. This determination may be made in any suitable fashion. In some embodiments of the invention, this determination is based at least in part on whether the budgeted compensation for each employee includes an increase which is equal to or greater than an amount that is calculated based on the estimated replacement cost calculated in the act 120 for the employee.

An example is shown in FIG. 3. In this example, the “Cost to Retain” (shown in column L) for each employee represents 30% of the “Cost to Replace” the employee (shown in column K). Thus, the estimated cost to retain employee 4 is $4,750.00, which is 30% of the estimated $15,833.33 cost to replace this employee, the estimated cost to retain employee 8 is $8,550.00, which is 30% of the estimated $28,500.00 to replace this 8, the estimated cost to retain employee 11 is $11,400.00, which is 30% of the estimated $38,000 to replace this employee, and the estimated cost to retain employee 12 is $12,350.00, which is 30% of the estimated $41,166.67 to replace this employee. For these employees, the determination in the act 130 involves a comparison between the budgeted compensation for each employee and the “Cost to Retain” amount shown in column L for the employee. If the budgeted compensation does not include an increase equal to the “Cost to Retain,” then it is determined that the budgeted compensation amount for the employee is not appropriate.

It should, of course, be appreciated that a determination whether the budgeted compensation for a particular employee is appropriate need not be based upon whether an increase that is equal to or greater than a percentage of the cost to replace the employee has been budgeted, as any suitable amount(s) may be used to assess whether suitable compensation has been budgeted. Any suitable technique(s) may alternatively be used.

It should also be appreciated that if a percentage of the estimated replacement cost is used to determine whether appropriate compensation has been budgeted, the same percentage need not be used for each employee. For example, the “Cost to Retain” a first employee (e.g., who performs a first function, works in a first geographic region, etc.) may be 20% of the “Cost to Replace” that employee, and the “Cost to Retain” a second employee (e.g., who performs another function, works in another geographic region, etc.) may be 40% of the “Cost to Replace” that employee. Any suitable technique and/or information may be used to determine whether an budgeted compensation amount is appropriate, as embodiments of the invention are not limited in this respect.

If it is determined in the act 130 that the budgeted compensation for one or more employees is not appropriate, then representative process 100 proceeds to act 140, wherein modifications to the amount(s) budgeted for the employee(s) may be recommended. This may be performed in any of numerous ways. In some embodiments of the invention, a recommendation to increase the budgeted compensation may be generated as a result of executing programmed instructions, and may be presented via a graphical user interface. The recommendation may, for example, be presented via the graphical user interface to a decision-maker in the organization having authority to modify employee compensation, such as a member of a central administrative team, or a manager of an employee deemed to be inappropriately compensated.

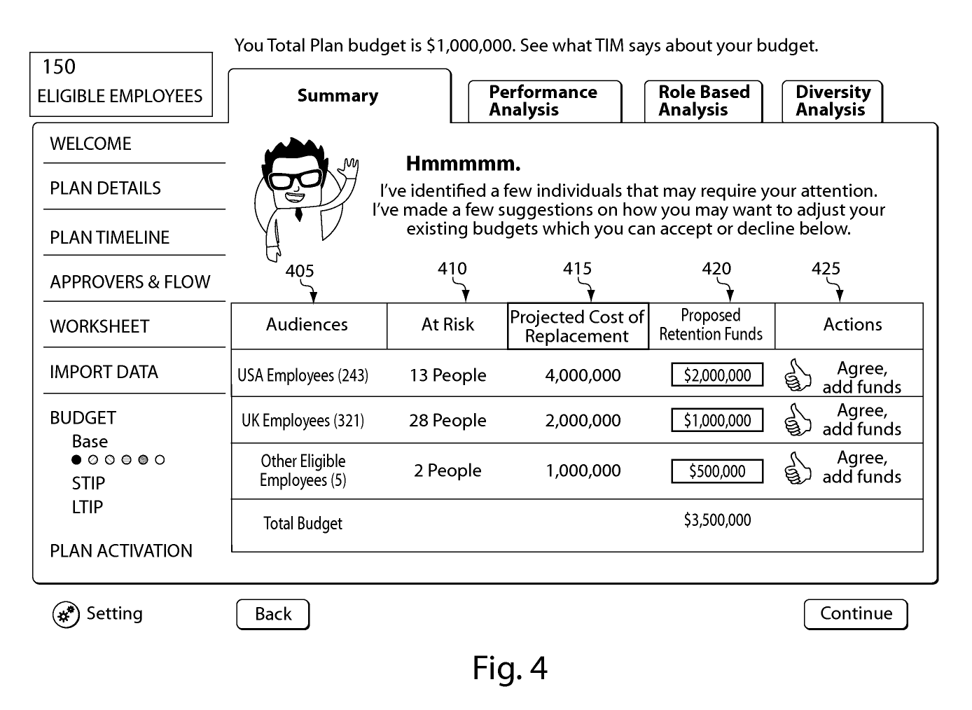

A representative graphical user interface 400 for presenting a recommendation is shown in FIG. 4. Representative interface 400 shows budget increase recommendations for three separate “audiences” (i.e., groups of employees) represented in column 405. It can be seen from FIG. 4 (i.e., at 401) that the original recommendation for aggregate compensation for these three audiences is $1,000,000. For each audience shown in column 405, a subset of the audience that has been identified as being “at risk” is shown in column 410. Thus, of the 243 members of the “USA Employees” audience represented in column 405, 13 people are shown as being “at risk” in column 410. Similarly, of the 321 members of the “UK Employees” audience represented in column 405, 28 people are shown as being “at risk,” and of the 5 “Other Eligible Employees” represented in column 405, 2 are shown as being “at risk” in column 410.

Column 415 shows an estimated replacement cost for the “at risk” population shown in column 410, and column 420 shows “Proposed Retention Funds” to be allocated to employee compensation in an attempt to retain this population. For the audience “USA employees,” the estimated replacement cost is $4,000,000.00, and the proposed retention funds are $2,000,000, or 50% of the estimated replacement cost. Similarly, for the audience “UK employees,” the estimated replacement cost is $2,000,000.00, so that the proposed retention funds are $1,000,000, and for the “Other Eligible Employees,” the estimated replacement cost is $1,000,000.00, so that the proposed retention funds are $500,000. As such, representative user interface 400 presents a recommendation to add $3,500,000.00 to the original compensation budget of $1,000,000.

Column 425 includes icons which enable a user to adopt a recommendation for a particular audience. Specifically, a user may provide input (e.g., by clicking using a device such as a mouse, by providing gesture and/or voice input, etc.) to an icon in a row to adopt the recommendation to increase the compensation for the audience in that row by the amount shown in column 420. The actions which are available to the user via the representative interface shown in FIG. 4 are merely illustrative, and not intended to be comprehensive. For example, a user interface implemented in accordance with embodiments of the invention may allow a user to decline and/or modify a particular budget recommendation.

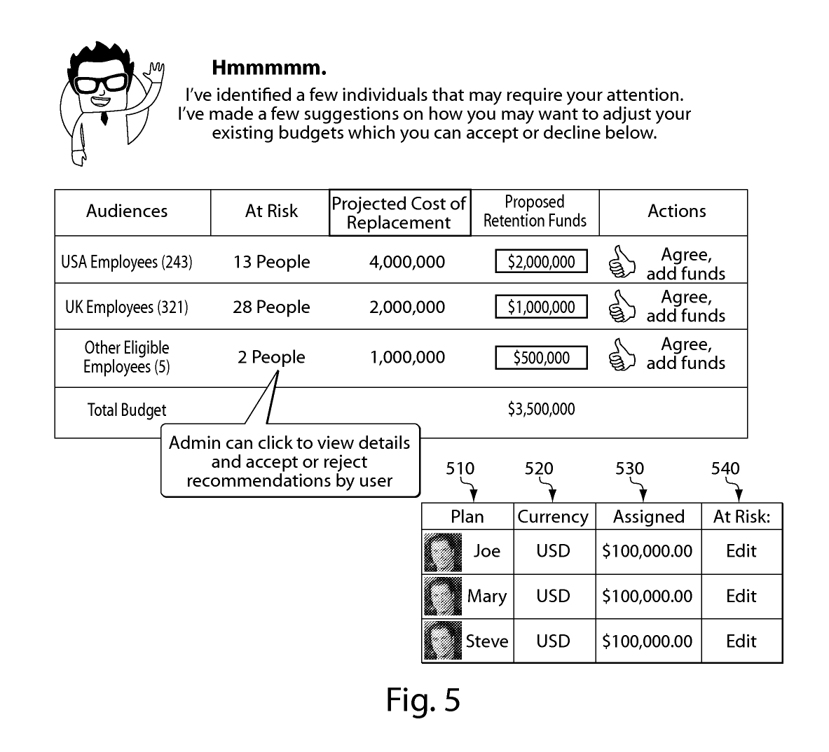

FIG. 5 depicts a representative user interface 500 which may be presented to provide additional information on an “at risk” population shown on representative user interface 400. Specifically, by providing input (e.g., clicking, providing voice and/or gesture input, hovering, etc.) to the “at risk” population for a particular audience represented in column 405, a user may cause representative interface 500 to be displayed. In the example shown, representative interface 500 presents information on the “at risk” population's members, including each employee's name (shown in column 510), the currency in which the employee is compensated (shown in column 520), and the recommended compensation increase for the employee (shown in column 530). Column 540 enables the user to edit the “at risk” designation for each employee represented in column 510. As with the example interface shown in FIG. 4, the actions available to the user via the representative interface 500 shown in FIG. 5 are merely illustrative, and not comprehensive. For example, a user interface implemented in accordance with some embodiments of the invention may enable a user to alter an amount budgeted for a particular employee and/or modify an employee's profile so that they may not be identified as critical to the organization. A user interface implemented in accordance with embodiments of the invention may present any suitable information, and enable a user to take any of numerous actions.

Referring again to FIG. 1, at the completion of act 140, or if it is determined in the act 130 that the budgeted amount is appropriate for “at risk” employees, representative process 100 completes.

It should be appreciated that a recommended increase to an “at risk” employee's compensation may take any suitable form. In this respect, some embodiments of the invention evidence a recognition that increasing an employee's salary may result in additional obligations being imposed on the organization, such as a corresponding increase in the employee's pension benefit, eligibility for additional benefits, an expectation that the employee's salary will be even greater in future years, etc. As such, some embodiments of the invention may recommend the form that a compensation increase should take (e.g., a salary increase, one-time bonus, a lump sum payment, option or stock grant, and/or some other form(s) of compensation increase). This recommendation may be based on any of numerous factors. In some embodiments, if a recommended compensation increase results in an employee's salary being within a predetermined percentage of the “market midpoint” salary for employees performing similar functions at other organizations, then an increase in salary may be recommended, given that many employees prefer salary increases over other forms of compensation increases. However, if a recommended compensation increase results in the employee's salary being above this predetermined percentage, then other forms of compensation increases may be recommended, such as a lump sum payment, spot bonus, option grant, etc.

Of course, any suitable technique, which may or may not be based upon a comparison between a budgeted salary amount and a “market midpoint” salary amount (or other amount) may be used to determine the form which a compensation increase should take, as embodiments of the invention are not limited in this respect.

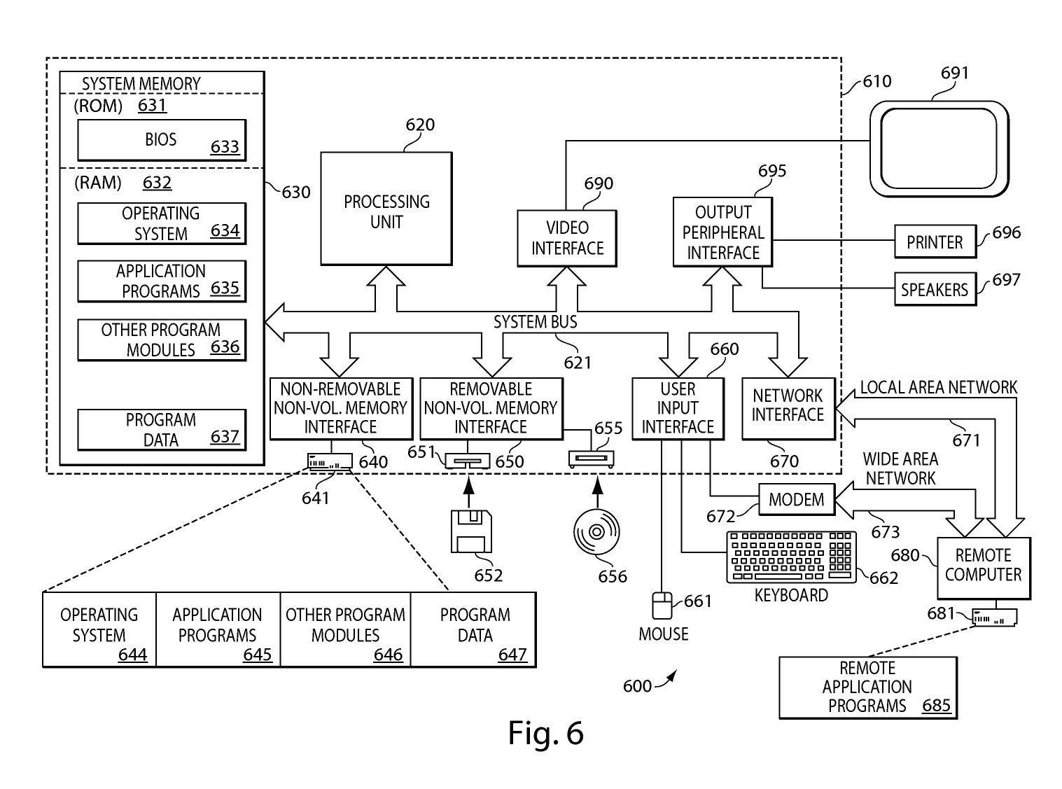

As should be apparent from the foregoing, some aspects of the invention may be implemented using a computing system. FIG. 6 illustrates one example of a computing system environment 600 which may be employed to implement some aspects of the invention. The computing system environment 600 is only one example of a suitable computing environment, and is not intended to suggest any limitation as to the scope of use or functionality of the invention. Neither should the computing environment 600 be interpreted as having any dependency or requirement relating to any one or combination of components illustrated in the exemplary operating environment 600. In this respect, the invention is operational with numerous other general purpose or special purpose computing system environments or configurations. Examples of well-known computing systems, environments, and/or configurations that may be suitable for use with the invention include, but are not limited to, personal computers, server computers, mobile or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

FIG. 6 depicts a general purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other one or more media which may be used to store the desired information and may be accessed by computer 610. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through an non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 536, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 560 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through a output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a tangible machine, mechanism or device from which a computer may read information. Alternatively or additionally, the invention may be embodied as a medium other than a computer-readable storage medium. For example, the invention may be embodied as a transitory medium such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing, and is therefore not limited in its application to the details and arrangement of techniques, steps and/or components set forth in the foregoing description or illustrated in the drawings. For example, aspects described in one embodiment may be combined in any manner with aspects described in other embodiments.

The invention may be embodied as a method, of which an example has been provided. The acts performed as part of the method may be ordered in any suitable way. Accordingly, embodiments may be constructed in which acts are performed in an order different than illustrated, which may include different acts than those which are described, and/or which may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for facilitating retention of employees by an organization, the method comprising acts of:
(A) identifying a subset of the organization's employees based at least in part upon:
one or more employees in the subset being deemed a risk to depart the organization;
one or more employees in the subset being deemed a high value employee to the organization; and/or
one or more employees in the subset being deemed underpaid by the organization;
(B) determining a cost to the organization of replacing the subset of the employees; and
(C) generating a recommendation to increase compensation for the identified subset of employees by a first amount, the first amount being determined based at least in part on the cost determined in the act (B).

2. The method of claim 1, wherein the first amount is a percentage of the cost determined in the act (B).

3. The method of claim 2, wherein the act (C) comprises generating a recommendation, for each employee in the subset of employees, to increase compensation by the same percentage of the cost determined in the act (B).

4. The method of claim 1, wherein the act (B) comprises determining a sum of an estimated cost to recruit a replacement for each employee of the subset of employees, an estimated cost to train a replacement for each employee of the subset of employees, and an estimated cost to provide a premium over the salary earned by each employee of the subset of employees.

5. The method of claim 1, wherein the act (C) comprises presenting the recommendation via a user interface to a user in the organization who has authority to make decisions regarding employee compensation.

6. The method of claim 1, wherein the act (A) comprises identifying the subset based at least in part upon one or more employees in the subset being deemed a high value employee to the organization, and wherein the one or more employees are deemed high value employees based at least in part upon assessments of how difficult it would be for the organization to replace the one or more employees, whether the skills of the one or more employees could be duplicated by other employees of the organization, and/or how long it would take the organization to train replacements for the one or more employees.

7. A system for facilitating retention of employees by an organization, the system comprising:
at least one computer processor programmed to;
identify a subset of the organization's employees based at least in part upon:
one or more employees in the subset being deemed a risk to depart the organization;
one or more employees in the subset being deemed a high value employee to the organization; and/or
one or more employees in the subset being deemed underpaid by the organization;
determine a cost to the organization of replacing the subset of the employees; and
generate a recommendation to increase compensation for the identified subset of employees by a first amount, the first amount being determined based at least in part on the determined cost to the organization.

8. The system of claim 7, wherein the first amount is a percentage of the determined cost to the organization.

9. The system of claim 8, wherein the at least one computer processor is programmed to generate a recommendation, for each employee in the subset of employees, to increase compensation by the same percentage of the determined cost to the organization.

10. The system of claim 7, wherein the at least one computer processor is programmed to determine the cost to the organization as a sum of an estimated cost to recruit a replacement for each employee of the subset of employees, an estimated cost to train a replacement for each employee of the subset of employees, and an estimated cost to provide a premium over the salary earned by each employee of the subset of employees.

11. The system of claim 7, wherein the at least one computer processor is programmed to present the recommendation via a user interface.

12. The system of claim 7, wherein the at least one computer processor is programmed to identify the subset based at least in part upon one or more employees in the subset being deemed a high value employee to the organization, and wherein the one or more employees are deemed high value employees based at least in part upon assessments of how difficult it would be for the organization to replace the one or more employees, whether the skills of the one or more employees could be duplicated by other employees of the organization, and/or how long it would take the organization to train replacements for the one or more employees.

13. At least one computer-readable storage medium having instructions encoded thereon which, when executed in a computer system, cause the computer system to perform a method for facilitating retention of employees by an organization, the method comprising acts of:
(A) identifying a subset of the organization's employees based at least in part upon:
one or more employees in the subset being deemed a risk to depart the organization;
one or more employees in the subset being deemed a high value employee to the organization; and/or
one or more employees in the subset being deemed underpaid by the organization;
(B) determining a cost to the organization of replacing the subset of the employees; and
(C) generating a recommendation to increase compensation for the identified subset of employees by a first amount, the first amount being determined based at least in part on the cost determined in the act (B).

14. The at least one computer-readable storage medium of claim 13, wherein the first amount is a percentage of the cost determined in the act (B).

15. The at least one computer-readable storage medium of claim 14, wherein the act (C) comprises generating a recommendation, for each employee in the subset of employees, to increase compensation by the same percentage of the cost determined in the act (B).

16. The at least one computer-readable storage medium of claim 13, wherein the act (B) comprises determining a sum of an estimated cost to recruit a replacement for each employee of the subset of employees, an estimated cost to train a replacement for each employee of the subset of employees, and an estimated cost to provide a premium over the salary earned by each employee of the subset of employees.

17. The at least one computer-readable storage medium of claim 13, wherein the act (C) comprises presenting the recommendation via a user interface to a user in the organization who has authority to make decisions regarding employee compensation.

18. The at least one computer-readable storage medium of claim 13, wherein the act (A) comprises identifying the subset based at least in part upon one or more employees in the subset being deemed a high value employee to the organization, and wherein the one or more employees are deemed high value employees based at least in part upon assessments of how difficult it would be for the organization to replace the one or more employees, whether the skills of the one or more employees could be duplicated by other employees of the organization, and/or how long it would take the organization to train replacements for the one or more employees.
